(19) United States
(12) Patent Application Publication
(10) Pub. No.: US 2005/0146103 A1
(43) Pub. Date: Jul. 7, 2005

(54) Clothesbasket and shopping cart

(76) Inventor: David G. Lampe, Bartelso, IL (US)

Correspondence Address: Richard C. Litman;LITMAN LAW OFFICES, LTD., P.O. Box 15035, Arlington, VA, 22215, US

(21) Appl. No.: 10/751,948

(22) Filed: Jan. 7, 2004

(51) Int. Cl. B62B 3/00

(52) U.S. Cl. 280/47.34

(57) ABSTRACT

A clothesbasket and shopping cart used to transport laundry and shopping items and accessories. The cart has an open-top rectangular shaped body to hold laundry and shopping items, a second enclosed area adjacent to the open-top rectangular shaped body for holding laundry and shopping accessories, a sliding top lid over the second enclosed area to protect the laundry and shopping accessories, a raised notch on the sliding top lid to assist in moving the sliding top lid, a structured frame to support the open-top rectangular shaped body and the second enclosed area, a handle extending from the structured frame that is conveniently adjacent to the sliding top lid and a plurality of oversized wheels set on the structured frame for easy and comfortable transport.

### BACKGROUND OF THE INVENTION

1. Field of the Invention

The present invention relates to carts in general, and more particularly to a clothesbasket and shopping cart.

2. Description of the Related Art

Washing clothes and shopping can be cumbersome drudgery, especially when carrying clothes and shopping items. There are a variety of different baskets and carts that are used to make carrying and transporting clothes and shopping items easier. These baskets and carts are reflected in the related art.

U.S. Pat. No. Des. 277,793 issued to Allen on Feb. 26, 1985, outlines an ornamental design for a folding shopper's cart in its unfolded condition of use.

U.S. Pat. No. Des. 348,549 issued to Trubiano on Jul. 5, 1994, outlines an ornamental design for an elevated shopping cart.

U.S. Pat. No. Des. 352,584 issued to Boyd on Nov. 15, 1994, outlines an ornamental design for a cart.

U.S. Pat. No. Des. 449,913 issued to Walter on Oct. 30, 2001, outlines an ornamental design for a shopping cart.

U.S. Pat. No. 3,245,498 issued to Stanley et al. on Apr. 12, 1966, outlines the use of a cart for transporting articles of the type having a wheeled frame of a shape to telescope in a correspondingly shaped frame of another cart and a receptacle having a bottom that is pivotly mounted on the frame for allowing a rocking movement from a forwardly extending position to an upright position by the engagement of its forward end with the rear of another cart.

U.S. Pat. No. 3,503,622 issued to Romero on Mar. 31, 1970, outlines the use of a supermarket cart with a supporting frame with spaced upright stanchions and forwardly tapered bars forming upper and lower supports open at one side to adapt them to telescope and nest in the frame of other carts, one within the other.

U.S. Pat. No. 4,537,413 issued to Rehrig on Aug. 27, 1985, outlines a basket for use as the rear basket in an over-the-counter cart having a horizontal frame to which a front and a rear basket are attached. The baskets have two opposed side panels, a rear panel and a bottom panel attached together along their contiguous edges. A back seat panel is pivotally attached to the side panels and a child's seat is pivotally attached to the bottom panel.

U.S. Pat. No. 4,726,596 issued to Ulmer on Feb. 23, 1988, outlines the use of a shopping cart having a pivoted platform mounting a pair of spaced caster assemblies. The platform has a pivot to permit each caster assembly to pivot independently of the other assembly to continuously engage a supporting surface to thereby avoid “three wheel” cart problems.

U.S. Pat. No. 4,763,907 issued to Raymond on Aug. 16, 1988, outlines the use of a utility wagon with a front-end wall and front sidewalls that are hinged so that they may move from a work position extending upward to a downward extending storage position. Rear sidewalls and a rear end wall are rigidly connected together and fixed to the base of the wagon for supporting the sidewalls of the work position with latches.

U.S. Pat. No. 5,074,570 issued to Ferris et al. on Dec. 24, 1991, outlines the use of a shopping cart having a side-opening gate arrangement associated with one of the basket sidewalls. The gate at its upper edge has a latch arrangement, which cooperates with the adjacent sidewalls to simply but securely maintain the gate in its closed position.

U.S. Pat. No. 5,203,578 issued to Davidson et al. on Apr. 20, 1993, outlines the use of a shopping cart and container for transporting grocery products in or about a store from a supermarket or the like and includes a plurality of containers and a cart for transporting the containers. The cart is made up an elongated wheeled base and at least one rack carried by the frame, which includes a shelf for supporting at least one of the containers.

U.S. Pat. No. 5,318,315 issued to White et al. on Jun. 7, 1994, outlines the use of a portable wheeled cart for yard and garden work, which includes a body having a bottom wall and a pair of opposing sidewalls extending from the bottom wall. The sidewalls include a plurality of open-ended passageways defined therein for receiving handles of yard tools.

U.S. Pat. No. 5,649,718 issued to Groglio on Jul. 22, 1997, outlines the use of a wheeled utility cart that includes a rigid rectangular basket component formed of molded plastic or a wired basket weave configuration. The wheels are relatively large to permit use of the cart on rough, soft and/or uneven surfaces, unlike the conventional small diameter casters provided on shopping carts. The wheels support the cart at a convenient height and the front and rear wheels are independently and automatically retractable, to permit the cart to be inserted into the back of a motor vehicle, such as a van, station wagon, or sport utility vehicle having a back door or gate.

U.S. Pat. No. 5,772,236 issued to Clark on Jun. 30, 1998, outlines the use of a new foldable laundry cart for offering a convenient way of storing, transporting and folding laundry. The inventive device includes a frame assembly having an opening therein, a basket fitted within the opening of the frame assembly, and first and second leg assemblies pivotably attached to opposite ends of the frame assembly.

U.S. Pat. No. 6,170,854 issued to Maher et al. on Jan. 9, 2001, outlines the use of a convertible stroller and shopping vehicle having a stroller portion and a shopping vehicle portion. The stroller portion includes a seat, which is movable from a deployed position to a stowed position. In the deployed position, the invention is used as a stroller.

French Patent No. EP 0286520 granted to Lemerre on Oct. 12, 1988, outlines the use of a shopping trolley with a rigid frame mounted on wheels, a quadrilateral rigid plate carried by the frame that forms the bottom of a basket with four flat rigid walls, namely two sidewalls formed by latticework, a front wall and a rear wall characterized in that it makes up at least one carrying handle and supports that are adjustable in height between the frame and the plate.

Although each of these patents outline the use of useful and novel inventions, what is really needed is a portable clothesbasket and shopping cart that has convenient and easily accessible storage compartment to hold auxiliary laundry and shopping items while in use. Such a clothesbasket and shopping cart would address a large demand of people who would purchase such an invention in the marketplace.

None of the above inventions and patents, taken singly or in combination, is seen to describe the instant invention as claimed. Thus a clothesbasket cart solving the aforementioned problems is desired.

### SUMMARY OF THE INVENTION

The invention is a clothesbasket and shopping cart used to transport laundry and shopping items and accessories. The cart has an open-top rectangular shaped body to hold laundry and shopping items, a second enclosed area adjacent to the open-top rectangular shaped body for holding laundry and shopping accessories, a sliding top lid over the second enclosed area to protect the laundry and shopping accessories, a raised notch on the sliding top lid to assist in moving the sliding top lid, a structured frame to support the open-top rectangular shaped body and the second enclosed area, a handle extending from the structured frame that is conveniently adjacent to the sliding top lid and a plurality of oversized wheels set on the structured frame for easy and comfortable transport.

Accordingly, it is a principal object of the invention to provide a clothesbasket and shopping cart that has oversized wheels to make the cart easy to push.

It is another object of the invention to provide a cart that has easy access to laundry and shopping accessories.

It is a further object of the invention to provide a cart that has a sliding door on the compartment for laundry and shopping accessories.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a clothesbasket and shopping cart according to the present invention.

FIG. 2 is a side perspective view of the clothesbasket and shopping cart.

FIG. 3 is a top plan view of the clothesbasket and shopping cart.

Similar reference characters denote corresponding features consistently throughout the attached drawings.

### DETAILED DESCRIPTION OF THE PREFERRED EMBODIMENT

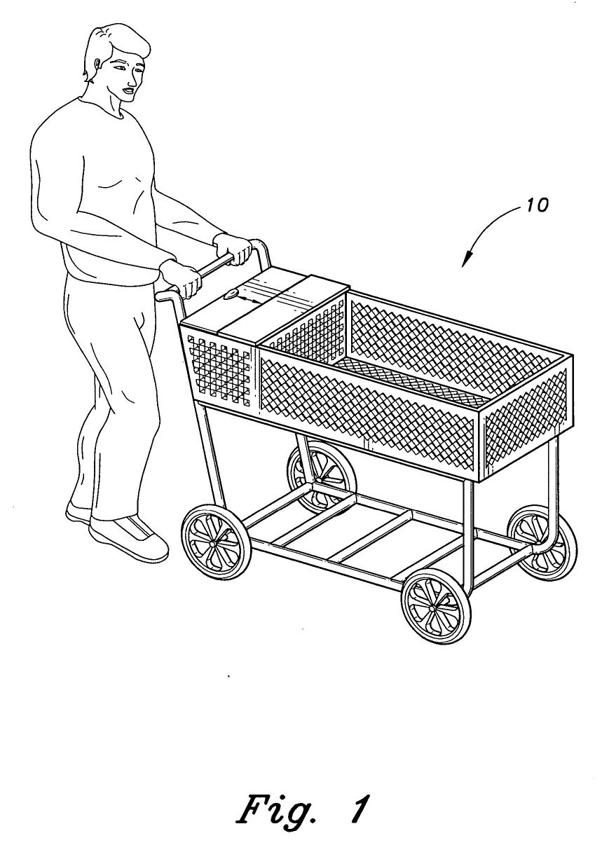

The present invention is a clothesbasket and shopping cart 10 used to transport laundry and shopping items and accessories, as is depicted in FIG. 1.

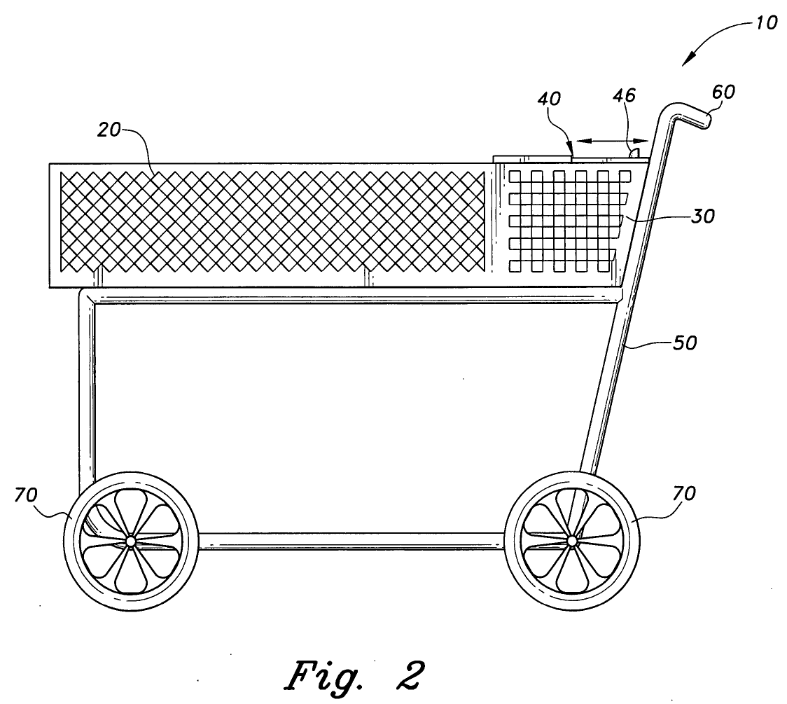

The clothesbasket and shopping cart 10 comprises an open-top rectangular shaped body 20 to hold laundry and shopping items, a second enclosed area 30 adjacent to the open-top rectangular shaped body 20 for holding laundry and shopping accessories and a sliding top lid 40 over the second enclosed area 30 to protect the laundry and shopping accessories. The clothesbasket and shopping cart 10 further comprises a structured frame 50 to support the open-top rectangular shaped body 20 and the second enclosed area 30, a handle 60 extending from the structured frame 50 that is conveniently adjacent to the sliding top lid 40 and a plurality of oversized wheels 70 set on the structured frame 50 for easy and comfortable transport. These features are depicted in FIG. 2.

The terms laundry and shopping: items are meant to describe the majority of the clothing and shopping materials that a user will use as part of their respective shopping and laundry activities. These can include clothes, packages, groceries and tangible shopping items that are used in a Laundromat or store setting. The term laundry and shopping accessories are meant to include smaller or accessory materials used in combination with the larger laundry and shopping items and can include clothespins, keys, wallets and shopping lists.

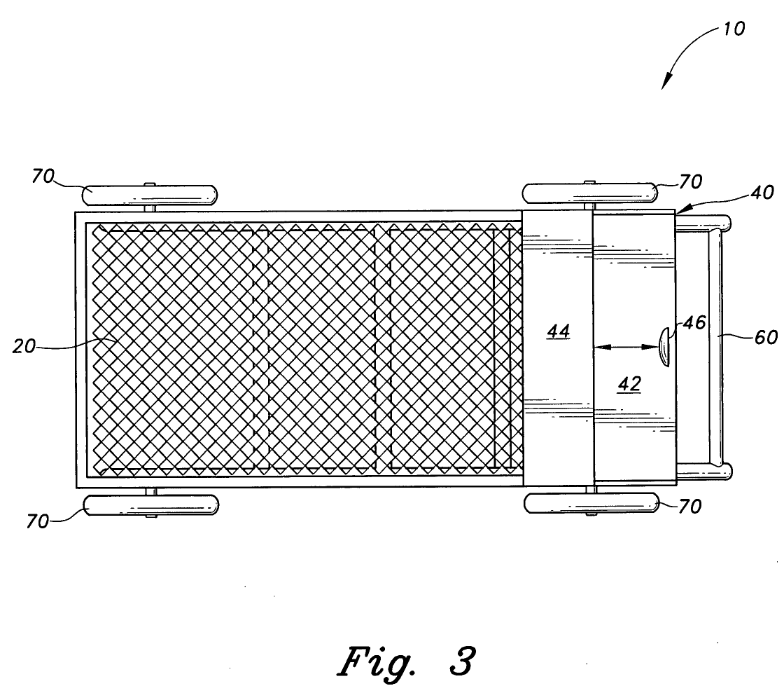

The open-top rectangular shaped body 20 of the clothesbasket and shopping cart 10 can carry and hold a laundry basket or other laundry and shopping items. The second enclosed area 30 is designed to hold laundry and shopping accessories, which are typically smaller than the laundry and shopping items held in the open-top rectangular shaped body 20. The second enclosed area 30 is conveniently set near the handle 60 and is provided with a sliding top lid 40 on top of the second enclosed area 30. The sliding top lid 40 is divided into two sections, one section adjacent to the handle 42 and the other section adjacent to the open top rectangular shaped body 44. The section adjacent to the handle 42 can be slid underneath the section adjacent to the open top rectangular shaped body 44. The section adjacent to the handle 42 has a raised notch 46 that allows a user to easily do just this. These features are depicted in FIG. 3.

An additional feature of the clothesbasket and shopping cart 10 is the presence of the plurality of oversized wheels 70. This is an important feature, particularly since the clothesbasket and shopping cart 10 will be wheeled onto a lawn or grassy surface to transport laundry to an outdoor clothesline and would more easily tip over if the plurality of oversized wheels 70 were not present.

Use of the clothesbasket and shopping cart 10 is uncomplicated. The clothesbasket and shopping cart 10 is designed for carrying clothes as well as shopping items and accessories. The clothesbasket and shopping cart 10 has an open-top rectangular shaped body 20 and a sliding top lid 40 are made of thermoplastic. The open-top rectangular shaped body 20 has weaved strands of thermoplastic while the sliding top lid is made of a sheet of thermoplastic material. The clothesbasket and shopping cart 10 also has a structured frame 50 and handle 60 which are made of metal tubing. Both the thermoplastic and metal handle materials are commonly used materials and are not a point of novelty with the clothesbasket and shopping cart 10.

It is to be understood that the present invention is not limited to the embodiment described above, but encompasses any and all embodiments within the scope of the following claims.

1. A clothesbasket and shopping cart used to transport laundry and shopping items and accessories, comprising:
an open-top rectangular shaped body to hold laundry and shopping items;
a second enclosed area adjacent to the enclosed open-top rectangular shaped body for holding laundry and shopping accessories;
a sliding top lid over the second enclosed area to protect the laundry and shopping accessories;
a raised notch on the sliding top lid to assist in moving the sliding top lid;
a structured frame to support the open-top rectangular shaped body and the second enclosed area;
a handle extending from the structured frame and conveniently adjacent to the sliding top lid; and
a plurality of oversized wheels set on the structured frame for easy and comfortable transport.

2. The clothesbasket and shopping cart according to claim 1, wherein the enclosed open-top rectangular shaped body and sliding top lid are made of a thermoplastic material.

3. The clothesbasket and shopping cart according to claim 1, wherein the structured frame and handle are made of metal tubing.
